(19) United States
(12) Patent Application Publication
(10) Pub. No.: US 2009/0089662 A1
(43) Pub. Date: Apr. 2, 2009

(54) SYSTEM AND METHOD FOR PROVIDING A MULTI-ROW CAPABLE TABLE

(76) Inventors: Michael Wulkan, Markham (CA); Jin Li, Markham (CA); Kimberley A. Peter, Toronto (CA)

Correspondence Address: HOFFMAN WARNICK LLC, 75 STATE ST, 14TH FLOOR, ALBANY, NY, 12207, US

(21) Appl. No.: 11/865,862

(22) Filed: Oct. 2, 2007

(51) Int. Cl. G06F 15/00

(52) U.S. Cl. 715/245

(57) ABSTRACT

The present invention is a system and method for showing as much horizontal data as possible without requiring horizontal scrolling while maintaining the attributes and benefits of a tabular display. This is achieved by dynamically splitting a row into two or more sub-rows when the row data would otherwise exceed the available horizontal space of the table control. This avoids the necessity to scroll, excessively compress the data or expand the table control. This is accomplished by the system having a tabular display unit for implementing the method comprising the steps of receiving a minimum size value of the tabular display; receiving a maximum size value of the tabular display; and dynamically splitting the horizontal data if the horizontal data exceeds the available horizontal space of the table control.

### FIELD OF THE INVENTION

The present invention relates generally to the sizing of the table columns and, more specifically, to a system and method for providing a multi-row capable table.

### BACKGROUND OF THE INVENTION

A table is a set of data elements (values) that is organized using a model of horizontal rows and vertical columns on GUI. In a table, the columns are identified by name, and the rows are identified by the values appearing in a particular column subset which has been identified as a candidate key. A table (in order to fit within the viewing GUI window) has a specified number of columns but can have any number of rows. Besides the actual data rows, tables generally have associated with them some meta-information, such as constraints on the table or on the values within particular columns. Tables are displayed on a user interface (GUI) of a user's computer.

When the width of data to be displayed in a tabular form exceeds the available width of the table control, not all the data can be seen because it is scrolled out of the view. (In computer graphics, scrolling or text crawling is the act of sliding a horizontal or vertical presentation of content, such as text, drawings, or images, across a screen or display window. Scrolling is often used to show large amounts of data that could not fit on the viewport all at the same time, this is commonly used in window-based computer displays. Scrolling is accomplished using horizontal or vertical scroll bars on the GUI.) There is a strong semantic association with the data elements displayed in a row of a table. Much of the cognitive value afforded by displaying this data in columns relative to each other is lost if the columns cannot be seen. The user loses the bird's eye view or, at a glance, the ability to see the data and relationships between data, and is forced to shift to a much more cumbersome scrolling back and forth action to take in the contents of the table. Some systems attempt to alleviate this problem by compressing the data within the individual columns of the row. For example, they may abbreviate the entry. This may be augmented by having a hover facility that expands the entry out-of-line when the mouse floats over the entry. A crude and obvious technique to solve this problem is to simply give the table more room. This is not always applicable or suitable to the application.

There presently is a need for a system and method for dynamically resizing the window without losing context and does not require table numbers (such as the left column in a spreadsheet) to identify the rows and for not eliminating any data and for a system and method which wraps the cells to multiple rows rather than reducing their size. There presently is a need for a system and method for shrinking the individual cells to a reasonable size before requiring the row to be wrapped so that multiple rows may be shown not requiring the user to hover over the row in order to see the missing data.

### BRIEF SUMMARY OF THE INVENTION

The present invention is a system and method for showing as much horizontal data as possible without requiring horizontal scrolling while maintaining the attributes and benefits of a tabular display. This is achieved by dynamically splitting a row into two or more sub-rows when the row data would otherwise exceed the available horizontal space of the table control. This avoids the necessity to scroll, excessively compress the data or expand the table control.

In addition, the present invention provides a system and method for showing, on a GUI, on a tabular display, as much horizontal data as possible without requiring horizontal scrolling while maintaining the attributes and benefits of the tabular display, the system having a tabular display unit for implementing the method comprising the steps of:

a. receiving a minimum size value of the tabular display;
b. receiving a maximum size value of the tabular display; and
c. dynamically splitting the horizontal data if the horizontal data exceeds the available horizontal space of the table control.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts table which fits within the GUI.

FIG. 2 shows how the system of the present invention operates.

FIG. 3 illustrates the method of the present invention.

FIG. 4 illustrates the processing system of the present invention.

FIG. 5 illustrates the communication between two basic data processing systems over a network.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method for the sizing of the table columns and, more specifically, to a system and method for providing a multi-row capable table.

When the table columns are defined, they are given the following attributes:

Minimum Size: value

Maximum Size: value

Dynamically Resizable: True/False

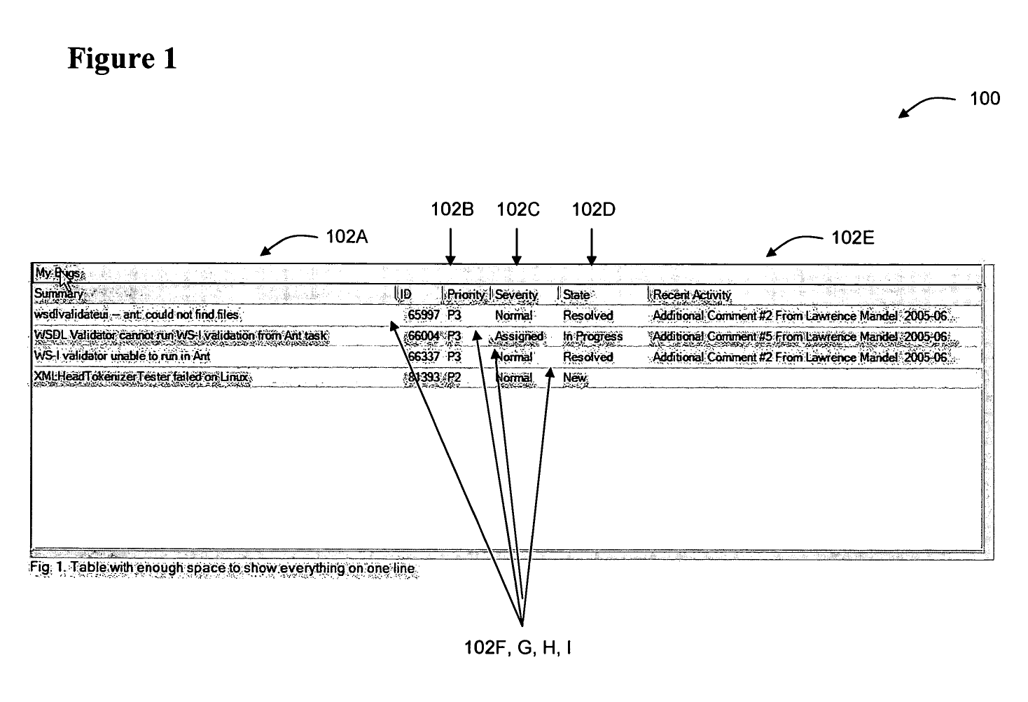

FIG. 1 illustrates a typical table 100 being displayed on a user's GUI. It comprises columns 102A, 102B, 102C, 102D and 102E. It also comprises rows 102F, 102G, 102H, and 102I. This table fits within the view of the GUI.

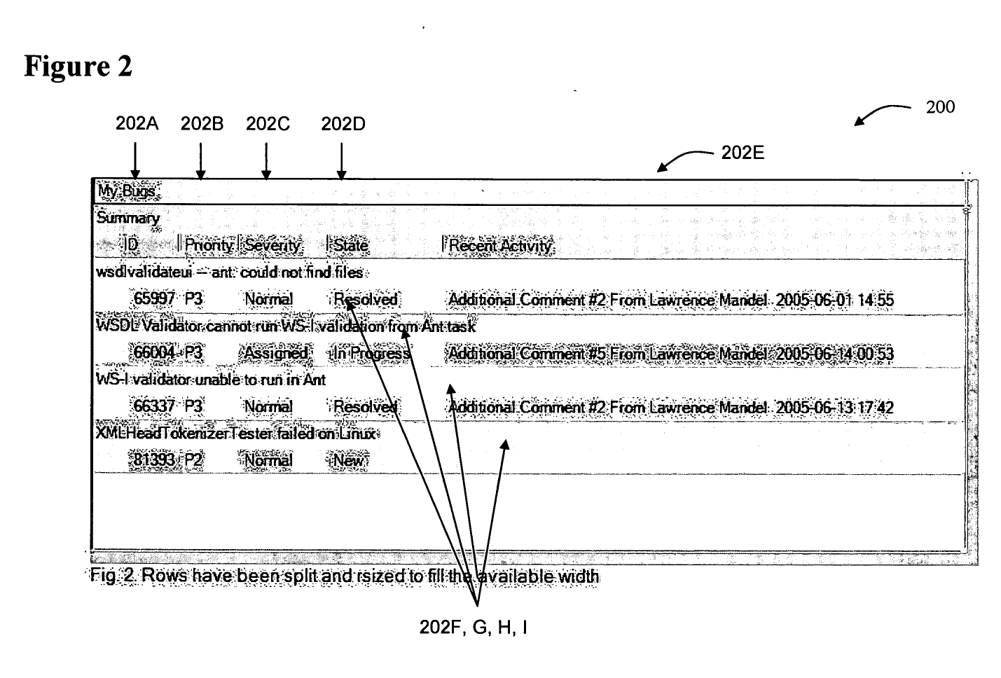

FIG. 2 illustrates the table 200 of the present invention being displayed on a user's GUI. It comprises columns 202A, 202B, 202C, 202D and 202E. It also comprises rows 202F, 202G, 202H, and 202I. This table does not fit within the view of the GUI so it is resized according to the method of the present invention.

As the width of the table is reduced, any columns that are designated as dynamically resizable are proportionally reduced in size until they reach their minimum size. Once all the dynamically resizable columns have reached their minimum size, i.e., the column cannot be reduced any more, the rows are split at the first column, wrapping all other columns onto a sub-row, and resized to fill the available width. The sub-rows are indented to show containment within the primary row.

Rows have been split and resized to fill the available width. As the width of the table is expanded, as soon as the table width is equal to or greater than the sum of the minimum sizes of all the columns, the rows are collapsed in reverse order of their split and resized to proportionately fill the available space.

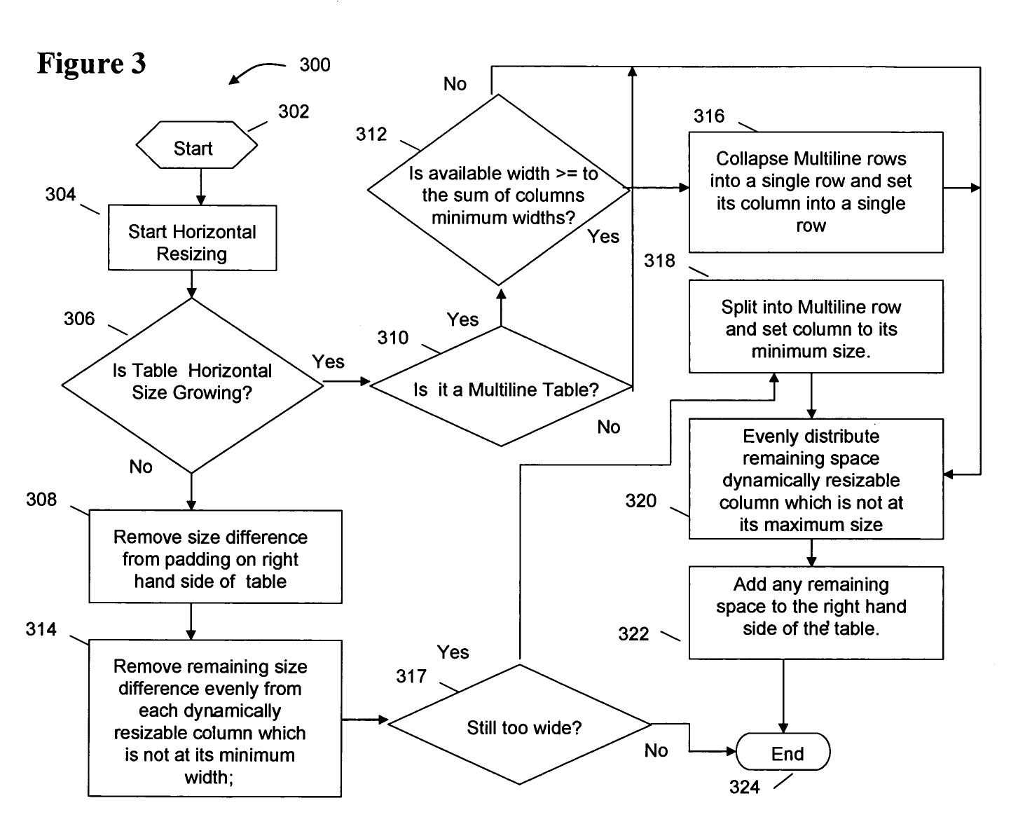

FIG. 3 illustrates a flow chart 300 of the Horizontal Resize Logic Flow method of the present invention. The present invention deals strictly with the sizing of the table columns. The techniques used to render the data within the columns, such as compressing data to allow the minimum size of a column to be less than the width of the column data, is beyond the scope of this invention disclosure. At 302, the method starts and continues to step 304 where the horizontal resizing process is started. At 306, it is determined whether table (or the tabular display) size is growing. At 308, if not, the method removes the size difference from padding on right hand side of table. At 314, the method removes remaining size difference evenly from each dynamically resizable column which is not at its minimum width. At 317, it is determined whether the table is still too wide. If not, the process ends at 324. If so, at 318, the system and method splits the horizontal data into a multiline row and sets the column to its minimum size. At 320, the method evenly distributes the remaining space dynamically into a resizable column which is not at its maximum size. At 322, the method adds any remaining space to the right hand side of the table. At step 324, the process ends.

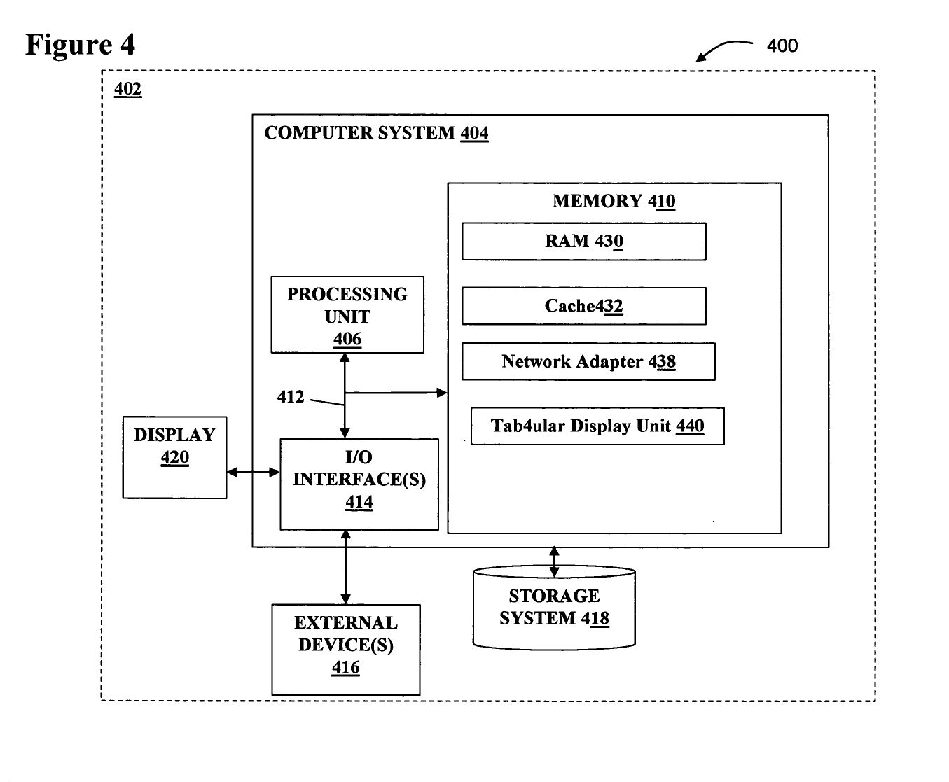

The data processing system of the present invention, such as that system 400 shown in FIG. 4, suitable for storing and/or executing program code will include at least one processor (processing unit 406) coupled directly or indirectly to memory elements through a system bus. The memory elements can include local memory (RAM 430) employed during actual execution of the program code, bulk storage (storage 418), and cache memories (cache 432) which provide temporary storage of at least some program code in order to reduce the number of times code must be retrieved from bulk storage during execution. Input/output or I/O devices (external devices 416) (including but not limited to keyboards, displays, pointing devices, etc.) can be coupled to the system either directly or through intervening I/O controllers (I/O Interface 414). The system of the present invention further includes a tabular display unit 440 for controlling the tabular resizing as discussed above.

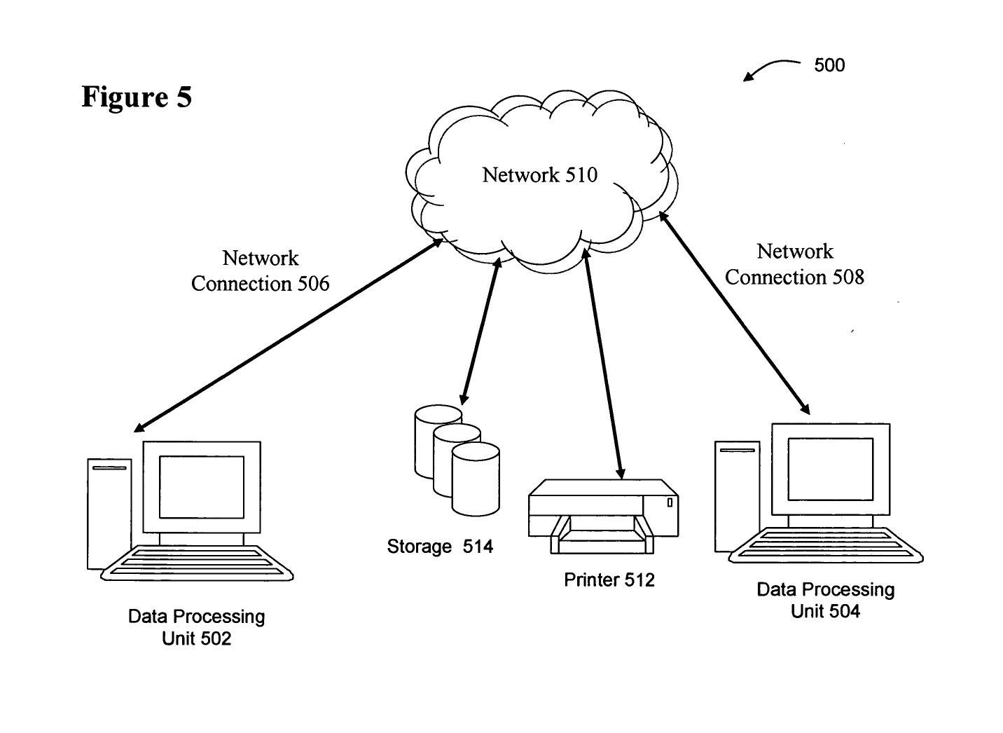

Network adapters (network adapter 438) may also be coupled to the system to enable the data processing system (as shown in FIG. 5, data processing unit 502) to become coupled to other data processing systems (data processing unit 504) or remote printers (printer 512) or storage devices (storage 514) through intervening private or public networks (network 510). (A computer network is composed of multiple computers connected together using a telecommunication system for the purpose of sharing data, resources and communication. For more information, see http://historyoftheinternet.org/). Modems, cable modems and Ethernet cards are just a few of the currently available types of network adapters. (A network card, network adapter or NIC (network interface card) is a piece of computer hardware designed to allow computers to communicate over a computer network. They are an OSI layer 1 (physical layer) and layer 2 (data link layer) devices, as they provide physical access to a networking medium and provides a low-level addressing system through the use of MAC addresses. They allow users to connect to each other either by using cables or wirelessly.)

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for showing, on a GUI, on a tabular display, as much horizontal data as possible without requiring horizontal scrolling while maintaining the attributes and benefits of the tabular display, the method comprising the steps of:
a. receiving a minimum size value of the tabular display;
b. receiving a maximum size value of the tabular display; and
c. dynamically splitting the horizontal data if the horizontal data exceeds the available horizontal space of the table control.

2. The method of claim 1 further comprising the step of starting the horizontal resizing.

3. The method of claim 1 further comprising the step of determining if the table horizontal size is growing and, if so, removing the size difference from padding on the right hand side of the tabular display.

4. The method of claim 3 further comprising the step of removing remaining size difference evenly from each dynamically resizable column which is not at its minimum width.

5. The method of claim 4 further comprising the steps of determining whether the table is still too wide and, if so, splitting the horizontal data into a multiline row and setting column size to its minimum size.

6. The method of claim 3 further comprising the steps of, if so, determining whether it is a multiline table and, if so, determining whether the available width is greater than or equal to the sum of columns minimum widths and, if so, collapsing the size of the column width.

7. The method of claim 6 further comprising the steps of evenly distributing the remaining space into a dynamically resizable column which is not at its maximum size and adding any remaining space to the right hand side of the table.

8. A computer program comprising program code stored on a computer-readable medium, which when executed, enables a computer system to implement the following steps in a method for showing, on a GUI, on a tabular display, as much horizontal data as possible without requiring horizontal scrolling while maintaining the attributes and benefits of the tabular display, the method comprising the steps of:
a. receiving a minimum size value of the tabular display;
b. receiving a maximum size value of the tabular display; and
c. dynamically splitting the horizontal data if the horizontal data exceeds the available horizontal space of the table control.

9. The computer program of claim 8 wherein the method further comprises the step of starting the horizontal resizing.

10. The computer program of claim 9 wherein the method further comprises the steps of determining if the table horizontal size is growing and, if so, removing the size difference from padding on the right hand side of the tabular display.

11. The computer program of claim 10 wherein the method further comprises the step of removing remaining size difference evenly from each dynamically resizable column which is not at its minimum width.

12. The computer program of claim 11 wherein the method further comprises the steps of determining whether the table is still too wide and, if so, splitting the horizontal data into a multiline row and setting column size to its minimum size.

13. The computer program of claim 12 wherein the method further comprises the steps of, if so, determining whether it is a multiline table and, if so, determining whether the available width is greater than or equal to the sum of columns minimum widths and, if so, collapsing the size of the column width.

14. The computer program of claim 13 wherein the method further comprises the steps of evenly distributing the remaining space into a dynamically resizable column which is not at its maximum size and adding any remaining space to the right hand side of the table.

15. A system for the sizing of the table columns and, more specifically, to a system for providing a multi-row capable table, having a CPU, a memory system for storing data, a graphical user interface (GUI) for displaying a tabular display to a user and a tabular display unit for dynamically resizing a table into a multi-row table.

16. The system of claim 15 wherein the tabular display unit further provides for the starting the horizontal resizing.

17. The system of claim 16 wherein the tabular display unit further provides for determining if the table horizontal size is growing and, if so, removing the size difference from padding on the right hand side of the tabular display.

18. The system of claim 17 wherein the tabular display unit further provides for removing remaining size difference evenly from each dynamically resizable column which is not at its minimum width.

19. The system of claim 18 wherein the tabular display unit further provides for determining whether the table is still too wide and, if so, splitting the horizontal data into a multiline row and setting column size to its minimum size.

20. The system of claim 19 wherein the tabular display unit further provides for determining whether it is a multiline table and, if so, determining whether the available width is greater than or equal to the sum of columns minimum widths and, if so, collapsing the size of the column width.

21. The system of claim 20 wherein the tabular display unit further provides for evenly distributing the remaining space into a dynamically resizable column which is not at its maximum size and adding any remaining space to the right hand side of the table.
